(19) United States
(12) Patent Application Publication
(10) Pub. No.: US 2023/0208035 A1
(43) Pub. Date: Jun. 29, 2023

(54) ANTENNA APPARATUS

(71) Applicant: Samsung Electro-Mechanics Co., Ltd., Suwon-si (KR)

(72) Inventors: Hwan JI, Suwon-si (KR); Jungil KIM, Suwon-si (KR); Hyunjun CHOI, Suwon-si (KR); Chin Mo KIM, Suwon-si (KR); Won Cheol LEE, Suwon-si (KR)

(73) Assignee: Samsung Electro-Mechanics Co., Ltd., Suwon-si (KR)

(21) Appl. No.: 17/981,668

(22) Filed: Nov. 7, 2022

(30) Foreign Application Priority Data
Dec. 24, 2021 (KR) 10-2021-0187402

(51) Int. Cl. H01Q 9/04

(52) U.S. Cl. CPC H01Q 9/0414; H01Q 9/045; H01Q 21/08

(57) ABSTRACT

An antenna apparatus includes a dielectric layer; and a via that extends through the dielectric layer, the via includes a conductive first portion and a non-conductive second portion surrounded by the conductive first portion. An antenna of the antenna apparatus is fed through the via.

### CROSS-REFERENCE TO RELATED APPLICATION

This application claims the benefit under 35 USC 119(a) of Korean Patent Application No. 10-2021-0187402, filed on Dec. 24, 2021, in the Korean Intellectual Property Office, the entire disclosure of which is incorporated herein by reference for all purposes.

### BACKGROUND

### 1. Field

The present disclosure relates to an antenna apparatus.

### 2. Description of the Related Art

The development of wireless communication systems has greatly changed our lifestyles over the past 20 years. Advanced mobile systems with gigabit data rates per second may be desired to support potential wireless applications such as multimedia devices, the Internet of things, and intelligent transportation systems. This is currently impossible to realize due to limited bandwidth in a 4G communication system. To overcome the problem of bandwidth limitations, the International Telecommunication Union has licensed a millimeter wave (mmWave) spectrum for a potential fifth-generation (5G) application range. Since then, there has been a lot of interest in research on mmWave antennas in both academia and industry.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an antenna apparatus includes a dielectric layer; and a via that extends through the dielectric layer, the via includes a conductive first portion and a non-conductive second portion surrounded by the conductive first portion. An antenna of the antenna apparatus is fed through the via.

The conductive first portion and the non-conductive second portion, in a thickness direction of the via, may have respective upper and/or lower surfaces aligned with a respective upper surface or lower surface of the dielectric layer.

The via further may include a lower surface that includes a conductive third portion connected to the lower surface of the conductive first portion.

The third portion of the via may be flush with, or higher than, a plane of the lower surface of the dielectric layer.

The via may further include an upper surface that includes a conductive fourth portion connected to the upper surface of the conductive first portion.

The fourth portion of the via may be flush with, or lower than, a plane of the upper surface of the dielectric layer.

The conductive first portion, the third portion, and the fourth portion of the via may surround the non-conductive second portion.

The antenna apparatus may further include a patch antenna fed from the via.

The patch antenna may be connected to the conductive first portion through the fourth portion.

The antenna apparatus may further include a plurality of connectors disposed under the first dielectric layer.

A subset of the connectors may be connected to the conductive first portion of the via through the third portion.

The conductive first portion may include a metal, and the non-conductive second portion may include at least one of air, glass, or ceramic.

The dielectric layer may include a first dielectric layer, a second dielectric layer disposed on the first dielectric layer, and a third dielectric layer disposed between the first dielectric layer and the second dielectric layer. A dielectric constant of the third dielectric layer may be lower than dielectric constants of the first dielectric layer and the second dielectric layer. The via may be disposed in at least the first dielectric layer.

The antenna apparatus may further include a feed patch antenna formed on the first dielectric layer and fed from the via, and a coupling patch formed on the second dielectric layer and coupled to the feed patch antenna.

The dielectric layer may have a hexahedron shape extending in a first direction, a second direction perpendicular to the first direction, and a third direction perpendicular to the first direction and the second direction.

The antenna apparatus may further include a plurality of connectors disposed under the first dielectric layer.

A subset of the connectors may be connected to the conductive first portion of the via.

In another general aspect, an antenna apparatus includes a dielectric layer; and a via that extends through the dielectric layer, the via includes a conductive first portion and a non-conductive second portion. The conductive first portion and the non-conductive second portion have respective upper and/or lower surfaces aligned with a respective upper surface or lower surface of the dielectric layer.

The via may further include a third portion connected to the conductive first portion and disposed on a lower surface of the via, and a fourth portion connected to the conductive first portion and disposed on an upper surface of the via. The third portion and the fourth portion may be disposed within the via.

The conductive first portion may include a metal, and the non-conductive second portion may include at least one of air, glass, or ceramic.

Other features and aspects will be apparent from the following detailed description, the drawings, and the claims.

### BRIEF DESCRIPTION OF THE DRAWINGS

FIG. 1 illustrates a cross-sectional view of an antenna apparatus according to an embodiment.

FIG. 2 illustrates a cross-sectional view of an antenna apparatus according to another embodiment.

FIG. 3 illustrates a cross-sectional view of a portion of an antenna apparatus according to an embodiment.

FIG. 4 illustrates a cross-sectional view of a portion of an antenna apparatus according to another embodiment.

FIG. 5 illustrates a cross-sectional view of a portion of an antenna apparatus according to another embodiment.

FIG. 6 illustrates a cross-sectional view of a portion of an antenna apparatus according to another embodiment.

FIG. 7A to FIG. 7E each illustrates a cross-sectional view showing an antenna apparatus manufacturing method according to an embodiment.

FIG. 8 illustrates a cross-sectional view of a portion of an antenna apparatus according to another embodiment.

FIG. 9 illustrates a cross-sectional view of a portion of an antenna apparatus according to another embodiment.

FIG. 10 illustrates a cross-sectional view of a portion of an antenna apparatus according to another embodiment.

FIG. 11 illustrates a schematic diagram showing an electronic device, including an antenna apparatus, according to an embodiment.

Throughout the drawings and the detailed description, the same reference numerals refer to the same or like elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Throughout the specification, a pattern, a via, a plane, a line, and an electrical connection structure may be formed of a metallic material (e.g., copper (Cu), aluminum (Al), silver (Ag), a conductive material such as tin (Sn), gold (Au), nickel (Ni), lead (Pb), titanium (Ti), or an alloy thereof), depending on a plating method such as a chemical vapor deposition (CVD) method, a physical vapor deposition (PVD) method, a sputtering method, a subtractive method, an additive method, a semi-additive process (SAP), a modified semi-additive process (MSAP), etc., but the embodiment is not limited thereto.

Throughout the specification, a dielectric layer may be implemented by using a thermosetting resin such as FR4, a liquid crystal polymer (LCP), a low temperature co-fired ceramic (LTCC), an epoxy resin, a thermoplastic resin such as a polyimide, or resins in which such a resin is impregnated into a core material such as a glass fiber (glass fiber, glass cloth, or glass fabric) together with an inorganic filler, a prepreg, an Ajinomoto build-up film (ABF), FR-4, bismaleimide triazine (BT), a photoimagable dielectric (PID) resin, a general copper clad laminate (CCL), or an insulating material such as glass or ceramic.

Throughout this specification, radio frequency (RF) signals may include Wi-Fi (IEEE 802.11 family, etc.), WiMAX (IEEE 802.16 family, etc.), IEEE 802.20, LTE (long term evolution), Ev-DO, HSPA+, HSDPA+, HSUPA+, EDGE, GSM, GPS, GPRS, CDMA, TDMA, DECT, Bluetooth, 3G, 4G, 5G, and any other wireless and wired protocols designated thereafter, but the embodiment is limited thereto.

It is found that as the size of the antenna module decreases, antenna performance, such as antenna gain and bandwidth, may typically deteriorate. For example, as the width of a via is narrowed in such a typical construction, it is found that a metal layer may not be uniformly filled inside the via of the same, or a void may be generated therein depending on a position of the via, and thereby, typical antenna performance may be lowered, or a defect in which the performance is not uniform may occur.

Hereinafter, various embodiments and variations will be described in detail with reference to drawings.

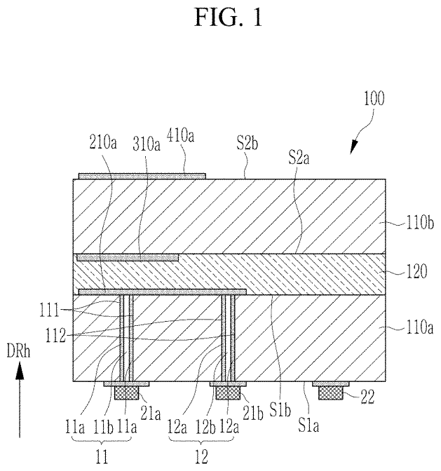

Hereinafter, an antenna apparatus 100 according to an embodiment will be described with reference to FIG. 1. FIG. 1 illustrates a cross-sectional view of an antenna apparatus according to an embodiment.

Referring to FIG. 1, the antenna apparatus 100, according to the present embodiment, may include a first dielectric layer 110a, a second dielectric layer 110b, and a third dielectric layer 120 disposed between the first dielectric layer 110a and the second dielectric layer 110b, a first via 11, a second via 12, patch antennas 210a, 310a, and 410a, and connectors 21a, 21b, and 22.

A dielectric constant of the first dielectric layer 110a and a dielectric constant of the second dielectric layer 110b may be greater than that of the third dielectric layer 120 disposed between the first dielectric layer 110a and the second dielectric layer 110b.

Thicknesses of the first dielectric layer 110a and the second dielectric layer 110b may be greater than that of the third dielectric layer 120, but the embodiment is not limited thereto.

The first dielectric layer 110a and the second dielectric layer 110b may each include a material having a relatively high dielectric constant, such as a ceramic-based material, e.g., a low temperature co-fired ceramic (LTCC), but the embodiment is not limited thereto.

The third dielectric layer 120 may include a different material from that of the first dielectric layer 110a and the second dielectric layer 110b. For example, the third dielectric layer 120 may include a polymer having adhesion to increase a bonding force between the first dielectric layer 110a and the second dielectric layer 110b. For example, the third dielectric layer 120 may include a ceramic material having a dielectric constant that is lower than that of the first dielectric layer 110a and the second dielectric layer 110b, a material having high flexibility, such as a liquid crystal polymer (LCP), or a polyimide, or a material such as an epoxy resin or Teflon to be highly durable and highly adhesive.

The first dielectric layer 110a may include a first surface S1a and a second surface S1b facing each other in a height direction DRh, the second dielectric layer 110b may include a first surface S2a and a second surface S2b facing each other in the height direction DRh, and the second surface S1b of the first dielectric layer 110a and the first surface S2a of the second dielectric layer 110b may face each other with the third dielectric layer 120 therebetween.

The antenna apparatus 100 may include: a first via 11 and a second via 12 passing through the first dielectric layer 110a along the height direction Drh; a first patch antenna 210a connected to the first via 11 and the second via 12 and disposed on the second surface S1b of the first dielectric layer 110a; a second patch antenna 310a disposed on the first surface S2a of the second dielectric layer 110b and disposed on the first patch antenna 210a; and a third patch antenna 410a disposed on the second surface S2b of the second dielectric layer 110b and disposed on the second patch antenna 310a.

The third dielectric layer 120 may be disposed between the first patch antenna 210a disposed on the second surface S1b of the first dielectric layer 110a and the second patch antenna 310a disposed on the first surface S2a of the second dielectric layer 110b.

The first patch antenna 210a may be connected to the first via 11 and the second via 12 to function and operate as a feeding patch. The first via 11 and the second via 12 may be feed vias that provide power to the feed patch.

The second patch antenna 310a and the third patch antenna 410a may be electromagnetically coupled to the first patch antenna 210a, to function and operate as a radiation patch.

The second patch antenna 310a and the third patch antenna 410a may concentrate RF signals in the height direction DRh to improve the gain or bandwidth of the first patch antenna 210a.

One of the second patch antenna 310a and the third patch antenna 410a may be omitted.

The first via 11 and the second via 12 may transfer electrical signals having different polarization characteristics, and surface currents flowing through the first patch antenna 210a in response to the electrical signals of the first via 11 and the second via 12 may flow perpendicular to each other. Accordingly, the antenna apparatus 100 may transmit and receive RF signals having different polarization characteristics.

The first via 11 may include a first portion 11a disposed on an inner wall of a first penetration hole 111, and a second portion 11b disposed inside the first penetration hole 111 surrounded by the first portion 11a.

Similarly, the second via 12 may include a first portion 12a disposed on an inner wall of a second penetration hole 112, and a second portion 12b disposed inside the second penetration hole 112 surrounded by the first portion 12a.

The first portion 11a and the second portion 11b of the first via 11 may include different materials, and the first portion 12a and the second portion 12b of the second via 12 may include different materials.

The first portion 11a of the first via 11 and the first portion 12a of the second via 12 may have conductivity, and the second portion 11b of the first via 11 and the second portion 12b of the second via 12 may have non-conductivity. For example, the first portion 11a of the first via 11 and the first portion 12a of the second via 12 may include a metal, and the second portion 11b of the first via 11 and the second portion 12b of the second via 12 may include a non-conductive material such as air, glass, or ceramic. In an example, the second portion 11b of the first via 11 and the second portion 12b of the second via 12 may include a non-conductive material. As a non-limiting example, the non-conductive material may include at least one of air, glass, or ceramic, e.g., air alone, an equal or variable combination of air and a glass, an equal or variable combination of the glass and a ceramic, equal or variable combinations of air, the glass, and the ceramic, etc. In an example, the at least one of the air, a glass, or a ceramic may additionally include different types of glass and/or ceramics, e.g., multiple types of glass, multiple types of ceramics, a glass and multiple types of ceramics, air and multiple types of ceramics, air and multiple types of glass, etc. In one non-limiting example, the second portions 11b and 12b are entirely filled by the at least one of the air, glass, or ceramics.

The first portions 11a and 12a of the first via 11 and the second portions 11b and 12b of the second via 12 along the height direction DRh may be flush with the first dielectric layer 110a, and the first penetration hole 111 and the second penetration hole 112.

A plurality of connectors 21a, 21b, and 22 are disposed on the first surface Sla of the first dielectric layer 110a.

The first connector 21a and the second connector 21b may be electrically connected to the first via 11 and the second via 12, respectively penetrating through the first dielectric layer 110a, in the illustrated thickness direction, among the connectors 21a, 21b, and 22. The third connector 22 is disposed on the first surface S1a of the first dielectric layer 110a among the connectors 21a, 21b, and 22, and thus the antenna apparatus 100 and an additional connection substrate may be connected to each other through the third connector 22.

The first via 11 and the second via 12 of the antenna apparatus 100 may respectively include the first portions 11a and 12a disposed on inner walls of the first penetration hole 111 and the second penetration hole 112 and including conductive materials, and the second portions 11b and 12b disposed inside the first penetration hole 111 and the second penetration hole 112 surrounded by the first portions 11a and 12a and including non-conductive materials.

When a via is formed in the dielectric layer, the via may be formed by drilling a penetration hole in the dielectric layer and then filling the penetration hole with a conductive paste and then firing it. In this case, when a diameter of the penetration hole becomes small, defects may occur inside the via, e.g., the conductive paste may be insufficiently filled, the filled conductive paste may be incompletely fired, the conductive paste may be contracted to create a void inside the via when the conductive paste is fired, or the like, and defects inside the via may vary depending on a position of the via. Non-uniformity of via defects depending on defects and the position of the via may cause non-uniformity in the performance of the antenna apparatus, including the via. This causes the antenna apparatus to be defective.

However, the antenna apparatus 100, according to the present embodiment, may form the first penetration hole 111 and the second penetration hole 112 respectively penetrating through the first dielectric layer 110a in the illustrated thickness direction, and the first portions 11a and 12a of the vias 11 and 12 may be formed by stacking a metallic material on inner walls of the first penetration hole 111 and the second penetration hole 112. In addition, the interiors of the first penetration hole 111 and the second penetration hole 112 surrounded by the first portions 11a and 12a of the vias 11 and 12 may be respectively filled with air or a non-conductive material such as glass or ceramic to form the second portions 11b and 12b.

As such, the first portions 11a and 12a of the vias 11 and 12 formed by stacking a metallic material on the inner walls of the first penetration hole 111 and the second penetration hole 112 may serve as metallic vias. In addition, portions surrounded by the first portion 11a and 12a of the vias 11 and 12 may include the second portions 11b and 12b, respectively, filled with a non-conductive material. The first portions 11a and 12a of the conductive vias 11 and 12 may include a non-conductive material therein, thereby preventing defects that may occur when the entire via is filled with a conductive material and formed, such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

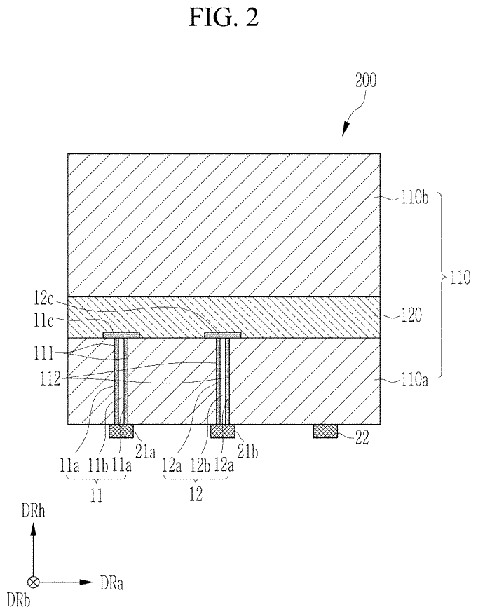

Hereinafter, an antenna apparatus 200, according to another embodiment, will be described with reference to FIG. 2. FIG. 2 illustrates a cross-sectional view of an antenna apparatus according to another embodiment.

Referring to FIG. 2, the antenna apparatus 200, according to the present embodiment, may include a dielectric block 110, and a first via 11 and a second via 12 extending through a portion of the dielectric block 110. The dielectric block 110 may extend in a height direction DRh and in planar directions DRa and DRb that are perpendicular to the height direction DRh.

The dielectric block 110 may include a first dielectric block 110a, a second dielectric block 110b disposed on the first dielectric block 110a along the height direction DRh, and a third dielectric block 120 disposed between the first dielectric block 110a and the second dielectric block 110b, but the embodiment is not limited thereto.

A dielectric constant of the first dielectric block 110a and the second dielectric block 110b may be higher than that of the third dielectric block 120, but the embodiment is not limited thereto, and dielectric constants of the first dielectric block 110a, the second dielectric block 110b, and the third dielectric block 120 are variable.

The first dielectric block 110a, the second dielectric block 110b, and the third dielectric block 120 may have a same planar shape to overlap each other along the height direction DRh.

The first dielectric block 110a, the second dielectric block 110b, and the dielectric block 110, including the third dielectric block 120, may each have, e.g., a rectangular parallelepiped shape, and the dielectric block 110 may have a first penetration hole 111 and a second penetration hole 112 into which the first via 11 and the second via 12 are inserted.

The first penetration hole 111 and the second penetration hole 112 may penetrate a portion of the dielectric block 110, e.g., the first dielectric block 110a of the dielectric material block 110.

The first via 11 and the second via 12 may transfer electric signals having different polarization characteristics. The dielectric block 110 may have resonance of a certain frequency in response to electrical signals of the first via 11 and the second via 12. Accordingly, the antenna apparatus 200 may transmit and receive RF signals having different polarization characteristics.

The first via 11 may include a first portion 11a disposed on an inner wall of a first penetration hole 111, and a second portion 11b disposed inside the first penetration hole 111 surrounded by the first portion 11a.

Similarly, the second via 12 may include a first portion 12a disposed on an inner wall of a second penetration hole 112, and a second portion 12b disposed inside the second penetration hole 112 surrounded by the first portion 12a.

The first portion 11a and the second portion 11b of the first via 11 may include different materials, and the first portion 12a and the second portion 12b of the second via 12 may include different materials.

The first portion 11a of the first via 11 and the first portion 12a of the second via 12 may be conductive. The second portion 11b of the first via 11 and the second portion 12b of the second via 12 may be non-conductive. For example, the first portion 11a of the first via 11 and the first portion 12a of the second via 12 may include a metal, and the second portion 11b of the first via 11 and the second portion 12b of the second via 12 may include a non-conductive material such as air, glass, or ceramic.

The antenna apparatus 200, according to the present embodiment, may be disposed on the first dielectric block 110a of the dielectric block 110 to include a first pattern 11c and a second pattern 12c connected to the first via 11 and the second via 12.

The first pattern 11c and the second pattern 12c may receive electromagnetic signals from the first via 11 and the second via 12, and may transmit the electromagnetic signals to the second dielectric block 110b of the dielectric block 110 and the third dielectric block 120. The first pattern 11c and the second pattern 12c may include the same material as that of the first portions 11a and 12a of the first via 11 and the second via 12, and the first pattern 11c and the second pattern 12c may be omitted.

The connectors 21a, 21b, and 22 may be disposed on a lower surface of the dielectric block 110.

The first connector 21a and the second connector 21b may be electrically connected to the first via 11 and the second via 12 among the connectors 21a, 21b, and 22. The third connector 22 may provide a connection between the antenna apparatus 200 and an additional connection substrate disposed under the dielectric block 110 among the connectors 21a, 21b, and 22.

As such, in accordance with the antenna apparatus 200 according to the present embodiment, it is possible to form the first penetration hole 111 and the second penetration hole 112 respectively penetrating through the first dielectric block 110a in the illustrated thickness direction, and it is possible to form the first portions 11a and 12a of the vias 11 and 12 by stacking a metallic material on inner walls of the first penetration hole 111 and the second penetration hole 112. In addition, the interiors of the first penetration hole 111 and the second penetration hole 112 surrounded by the first portions 11a and 12a of the vias 11 and 12 may be respectively filled with air or a non-conductive material such as glass or ceramic to form the second portions 11b and 12b.

As such, the first portions 11a and 12a of the vias 11 and 12 formed by stacking a metallic material on the inner walls of the first penetration hole 111 and the second penetration hole 112 may serve as metallic vias. The portions surrounded by the first portion 11a and 12a of the vias 11 and 12 may respectively include the second portions 11b and 12b filled with a non-conductive material. The first portions 11a and 12a of the conductive vias 11 and 12 may include a non-conductive material therein, thereby preventing defects that may occur when the entire via is filled with a conductive material and formed, such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

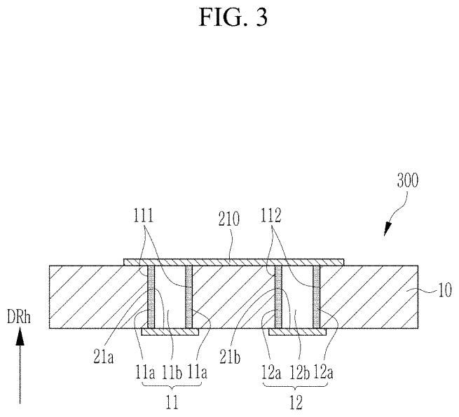

Hereinafter, an antenna apparatus 300, according to another embodiment, will be described with reference to FIG. 3. FIG. 3 illustrates a cross-sectional view of a portion of an antenna apparatus according to another embodiment.

Referring to FIG. 3, the antenna apparatus 300, according to the present embodiment, may include a dielectric layer 10, a first via 11 and a second via 12 formed in the dielectric layer 10, a patch antenna 210 connected to the first via 11 and the second via 12 and disposed on the dielectric layer 10, and connectors 21a and 21b disposed under the dielectric layer 10 and connected to the first via 11 and the second via 12.

The first via 11 may include a first portion 11a disposed on an inner wall of the first penetration hole 111, and a second portion 11b disposed inside the first penetration hole 111 surrounded by the first portion 11a, while the second via 12 may include a first portion 12a disposed on an inner wall of the second penetration hole 112, and a second portion 12b disposed inside the second penetration hole 112 surrounded by the first portion 12a.

The first portion 11a of the first via 11 and the first portion 12a of the second via 12 may have conductivity, and the second portion 11b of the first via 11 and the second portion 12b of the second via 12 may have non-conductivity. For example, the first portion 11a of the first via 11 and the first portion 12a of the second via 12 may include a metal, and the second portion 11b of the first via 11 and the second portion 12b of the second via 12 may include a non-conductive material such as air, glass, or ceramic.

The first portions 11a and 12a of the first via 11 and the second portions 11b and 12b of the second via 12 along the height direction DRh may be flush with the dielectric layer 10, and thus may be flush with the first penetration hole 111 and the second penetration hole 112 formed in the dielectric layer 10. That is, the first portions 11a and 12a and the second portions 11b and 12b of the first via 11 and the second via 12 may not protrude further than upper and lower surfaces of the dielectric layer 10.

The patch antenna 210 may receive electromagnetic signals from the first via 11 and the second via 12 to transmit and receive RF signals.

In accordance with the antenna apparatus 300 according to the present embodiment, the first portions 11a and 12a of the vias 11 and 12 formed by stacking a metallic material on the inner walls of the first penetration hole 111 and the second penetration hole 112 extending through the dielectric layer 10 may serve as metallic vias. The portions surrounded by the first portions 11a and 12a of the vias 11 and 12 may respectively include the second portions 11b and 12b filled with a non-conductive material, so that the first portions 11a and 12a of the conductive vias 11 and 12 may include a non-conductive material therein, thereby preventing defects such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

Many features of the antenna apparatuses 100 and 200, according to the embodiment described above, are applicable to the antenna apparatus 300 according to the present embodiment.

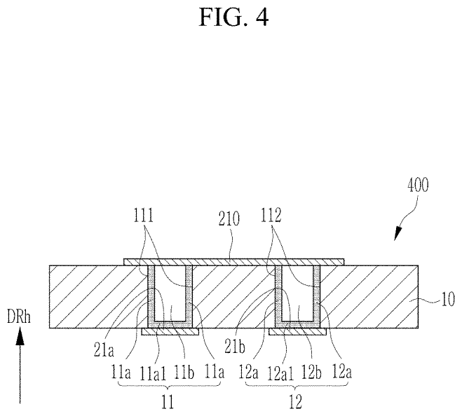

Hereinafter, an antenna apparatus 400 according to another embodiment will be described with reference to FIG. 4. FIG. 4 illustrates a cross-sectional view of a portion of an antenna apparatus according to another embodiment.

Referring to FIG. 4, the antenna apparatus 400, according to the present embodiment, may include a dielectric layer 10, a first via 11 and a second via 12 formed in the dielectric layer 10, a patch antenna 210 connected to the first via 11 and the second via 12 and disposed on the dielectric layer 10, and connectors 21a and 21b disposed under the dielectric layer 10 and connected to the first via 11 and the second via 12.

The first via 11 may include a first portion 11a disposed on an inner wall of the first penetration hole 111, a third portion 11a1 connected to the first portion 11a and disposed to block a lower surface of the first penetration hole 111, and a second portion 11b disposed inside the first penetration hole 111 surrounded by the first portion 11a and the third portion 11a1, while the second via 12 may include a first portion 12a disposed on an inner wall of the second penetration hole 112, a third portion 12a1 connected to the first portion 12a and disposed to block a lower surface of the first penetration hole 112, and a second portion 12b disposed inside the second penetration hole 112 surrounded by the first portion 12a and the third portion 12a1.

The first portion 11a and the third portion 11a1 of the first via 11 and the first portion 12a and the third portion 12a1 of the second via 12 may have conductivity, and the second portion 11b of the first via 11 and the second portion 12b of the second via 12 may have non-conductivity. For example, the first portion 11a and the third portion 11a1 of the first via 11 and the first portion 12a and the third portion 12a1 of the second via 12 may include a metal, and the second portion 11b of the first via 11 and the second portion 12b of the second via 12 may include a non-conductive material such as air, glass, or ceramic.

The first via 11 and the second via 12, including the first portions 11a and 12a, the third portions 11a1 and 12a1, and the second portions 11b and 12b along the height direction DRh may be flush with the dielectric layer 10, and may be flush with the first penetration hole 111 and the second penetration hole 112 formed in the dielectric layer 10.

The third portions 11a1 and 12a1 of the first via 11 and the second via 12 may not protrude from lower surfaces of the penetration holes 111 and 112, and may be disposed within the penetration holes 111 and 112.

Connections between the vias 11 and 12 and the connectors 21a and 21b may be better maintained by the third portions 11a1 and 12a1 of the first via 11 and the second via 12.

The patch antenna 210 may receive electromagnetic signals from the first via 11 and the second via 12 to transmit and receive RF signals.

In accordance with the antenna apparatus 300 according to the present embodiment, the first portions 11a and 12a of the vias 11 and 12 are formed by stacking a metallic material on inner walls and lower portions of the first penetration hole 111 and the second penetration hole 112 extending through the dielectric layer 10, and the third portions 11a1 and 12a1 connected to the first portions 11a and 12a are formed on lower surfaces of the first penetration hole 111 and the second penetration hole 112 by a screen printing method. Accordingly, the vias 11 and 12 may include the first portions 11a and 12a and the third portions 11a1 and 12a1 of vias 11 and 12 serving as metallic vias, and the second portions 11b and 12b formed by filling a non-conductive material in a portion surrounded by first portions 11a and 12a and third portions 11a1 and 12a1 of the vias 11 and 12, so that the first portions 11a and 12a and the third portions 11a1 and 12a1 of the conductive vias 11 and 12 may include a non-conductive material, thereby preventing defects such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

Many features of the antenna apparatuses 100, 200, and 300 according to the embodiment described above are applicable to the antenna apparatus 400 according to the present embodiment.

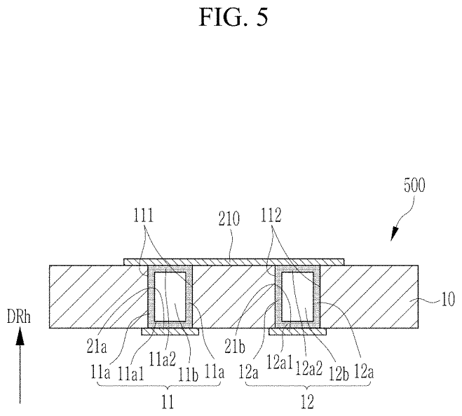

Hereinafter, an antenna apparatus 500 according to another embodiment will be described with reference to FIG. 5. FIG. 5 illustrates a cross-sectional view of a portion of an antenna apparatus according to another embodiment.

Referring to FIG. 5, the antenna apparatus 500, according to the present embodiment, may include a dielectric layer 10, a first via 11 and a second via 12 formed in the dielectric layer 10, a patch antenna 210 connected to the first via 11 and the second via 12 and disposed on the dielectric layer 10, and connectors 21a and 21b disposed under the dielectric layer 10 and connected to the first via 11 and the second via 12.

The first via 11 may include a first portion 11a disposed on the inner wall of the first penetration hole 111, a third portion 11a1 connected to the first portion 11a and disposed to block a lower surface of the first penetration hole 111, a fourth portion 11a2 connected to the first portion 11a and disposed to block an upper surface of the first penetration hole 111, and a second portion 11b disposed inside the first penetration hole 111 surrounded by the first portion 11a, the third portion 11a1, and the fourth portion 11a2.

The second via 12 may include a first portion 12a disposed on the inner wall of the second penetration hole 112, a third portion 12a1 connected to the first portion 12a and disposed to block a lower surface of the second penetration hole 112, a fourth portion 12a2 connected to the first portion 12a and disposed to block an upper surface of the second penetration hole 112, and a second portion 12b disposed inside the second penetration hole 112 surrounded by the first portion 12a, the third portion 12a1, and the fourth portion 12a2.

The first portion 11a, the third portion 11a1, and the fourth portion 11a2 of the first via 11, and the first portion 12a, the third portion 12a1, and the fourth portion 12a2 of the second via 12 may have a conductive material, and the second portion 11b of the first via 11 and the second portion 12b of the second via 12 may include air.

The first via 11 and the second via 12, including the first portions 11a and 12a, the third portions 11a1 and 12a1, the fourth portions 11a2 and 12a2, and the second portions 11b and 12b along the height direction DRh may be flush with the dielectric layer 10, and may be flush with the first penetration hole 111 and the second penetration hole 112 formed in the dielectric layer 10.

The third portions 11a1 and 12a1 and the fourth portions 11a2 and 12a2 of the first via 11 and the second via 12 may not protrude from lower surfaces and upper surfaces of the penetration holes 111 and 112, and may be disposed within the penetration holes 111 and 112.

Connections between the vias 11 and 12 and the connectors 21a and 21b may be better maintained by the third portions 11a1 and 12a1 of the first via 11 and the second via 12, and connections between the vias 11 and 12 and the patch antenna 210 may be better maintained by the fourth portions 11a2 and 12a2 of the first via 11 and the second via 12.

The patch antenna 210 may receive electromagnetic signals from the first via 11 and the second via 12 to transmit and receive RF signals.

In accordance with the antenna apparatus 500 according to the present embodiment, the first portions 11a and 12a of the vias 11 and 12 are formed by stacking a metallic material on inner walls of the first penetration hole 111 and the second penetration hole 112 extending through the dielectric layer 10, and a metallic material layer is printed by screen printing to form the third portions 11a1 and 12a1 and the fourth portions 11a2 and 12a2. Accordingly, the vias 11 and 12 may include the first portions 11a and 12a, the third portions 11a1 and 12a1, and the fourth portions 11a2 and 12a2 of vias 11 and 12 serving as metallic vias, and the second portions 11b and 12b formed by filling a non-conductive material in a portion surrounded by the first portions 11a and 12a, the third portions 11a1 and 12a1, and the fourth portions 11a2 and 12a2 of the vias 11 and 12, so that the first portions 11a and 12a, the third portions 11a1 and 12a1, and the fourth portions 11a2 and 12a2 of the conductive vias 11 and 12 may include a non-conductive material, thereby preventing defects such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

Many features of the antenna apparatuses 100, 200, 300, and 400 according to the embodiment described above are applicable to the antenna apparatus 500 according to the present embodiment.

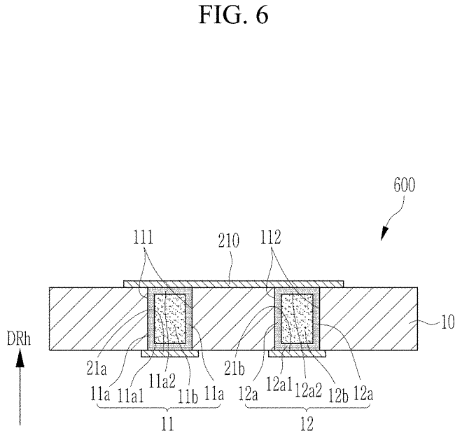

Hereinafter, an antenna apparatus 600, according to another embodiment, will be described with reference to FIG. 6. FIG. 6 illustrates a cross-sectional view of a portion of an antenna apparatus according to another embodiment.

Referring to FIG. 6, the antenna apparatus 600, according to the present embodiment, is similar to the antenna apparatus 600 according to the embodiment described above.

The antenna apparatus 600 according to the present embodiment may include a dielectric layer 10, a first via 11 and a second via 12 formed in the dielectric layer 10, a patch antenna 210 connected to the first via 11 and the second via 12 and disposed on the dielectric layer 10, and connectors 21a and 21b disposed under the dielectric layer 10 and connected to the first via 11 and the second via 12.

The first via 11 may include a first portion 11a disposed on the inner wall of the first penetration hole 111, a third portion 11a1 connected to the first portion 11a and disposed to block a lower surface of the first penetration hole 111, a fourth portion 11a2 connected to the first portion 11a and disposed to block an upper surface of the first penetration hole 111, and a second portion 11b disposed inside the first penetration hole 111 surrounded by the first portion 11a, the third portion 11a1, and the fourth portion 11a2.

The second via 12 may include a first portion 12a disposed on the inner wall of the second penetration hole 112, a third portion 12a1 connected to the first portion 12a and disposed to block a lower surface of the second penetration hole 112, a fourth portion 12a2 connected to the first portion 12a and disposed to block an upper surface of the second penetration hole 112, and a second portion 12b disposed inside the second penetration hole 112 surrounded by the first portion 12a, the third portion 12a1, and the fourth portion 12a2.

The first portion 11a, the third portion 11a1, and the fourth portion 11a2 of the first via 11, and the first portion 12a, the third portion 12a1, and the fourth portion 12a2 of the second via 12 may have conductivity, and the second portion 11b of the first via 11 and the second portion 12b of the second via 12 may have non-conductivity. For example, the first portion 11a, the third portion 11a2, and the fourth portion 11a2 of the first via 11 and the first portion 12a, the third portion 12a2, and the fourth portion 12a2 of the second via 12 may include a metal, and the second portion 11b of the first via 11 and the second portion 12b of the second via 12 may include a non-conductive material such as glass or ceramic rather than air.

The first via 11 and the second via 12 including the first portions 11a and 12a, the third portions 11a1 and 12a1, the fourth portions 11a2 and 12a2, and the second portions 11b and 12b along the height direction DRh may be flush with the dielectric layer 10, and may be flush with the first penetration hole 111 and the second penetration hole 112 formed in the dielectric layer 10.

The third portions 11a1 and 12a1 and the fourth portions 11a2 and 12a2 of the first via 11 and the second via 12 may not protrude from lower surfaces and upper surfaces of the penetration holes 111 and 112, and may be disposed within the penetration holes 111 and 112.

Connections between the vias 11 and 12 and the connectors 21a and 21b may be better maintained by the third portions 11a1 and 12a1 of the first via 11 and the second via 12, and connections between the vias 11 and 12 and the patch antenna 210 may be better maintained by the fourth portions 11a2 and 12a2 of the first via 11 and the second via 12.

The second portion 11b of the first via 11 and the second portion 12b of the second via 12 may be filled with a non-conductive material such as glass or ceramic rather than air, thereby more stably maintaining a shape of the vias 11 and 12.

The patch antenna 210 may receive electromagnetic signals from the first via 11 and the second via 12 to transmit and receive RF signals.

In accordance with the antenna apparatus 500 according to the present embodiment, the first portions 11a and 12a of the vias 11 and 12 are formed by stacking a metallic material on inner walls of the first penetration hole 111 and the second penetration hole 112 extending through the dielectric layer 10, and the third portions 11a1 and 12a1 and the fourth portions 11a2 and 12a2 of the vias 11 and 12 are formed by screen printing the metallic material layer. Accordingly, the vias 11 and 12 may include the first portions 11a and 12a, the third portions 11a1 and 12a1, and the fourth portions 11a2 and 12a2 of vias 11 and 12 serving as metallic vias, and the second portions 11b and 12b formed by filling a non-conductive material in a portion surrounded by the first portions 11a and 12a, the third portions 11a1 and 12a1, and the fourth portions 11a2 and 12a2 of the vias 11 and 12, so that the first portions 11a and 12a, the third portions 11a1 and 12a1, and the fourth portions 11a2 and 12a2 of the conductive vias 11 and 12 may include a non-conductive material, thereby preventing defects such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

Many features of the antenna apparatuses 100, 200, 300, 400, and 500, according to the embodiment described above, are applicable to the antenna apparatus 600 according to the present embodiment.

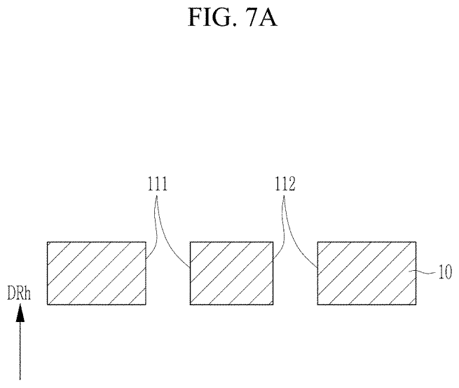

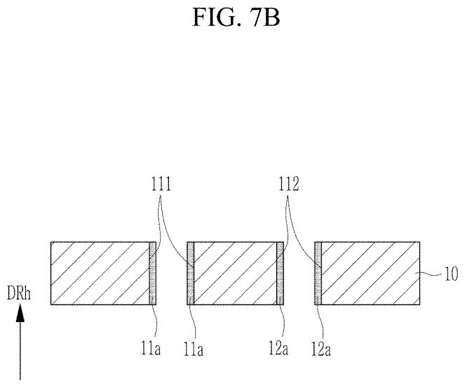

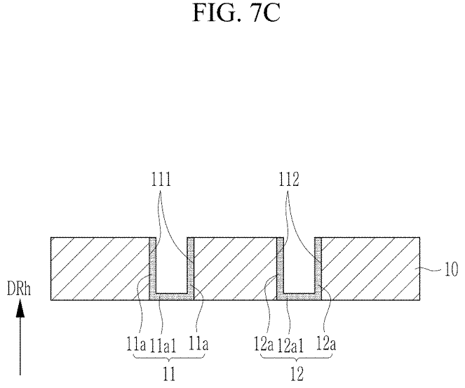

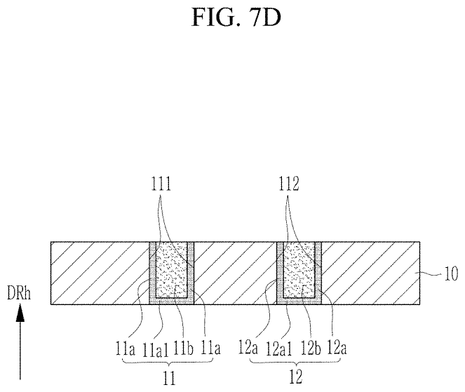

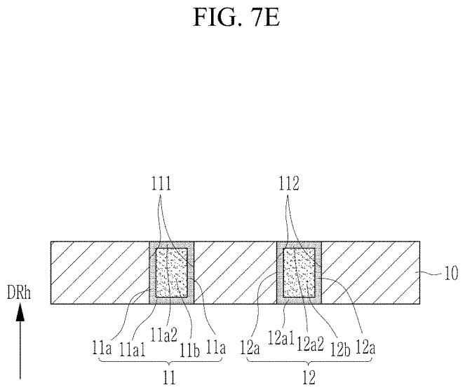

Hereinafter, a manufacturing method of an antenna apparatus according to an embodiment will be described with reference to FIG. 7A to FIG. 7E. FIG. 7A to FIG. 7E each illustrates a cross-sectional view showing an antenna apparatus manufacturing method according to an embodiment.

Referring to FIG. 7A, penetration holes 111 and 112 are formed in the dielectric layer 10 using a laser or the like.

As illustrated in FIG. 7B, the first portions 11a and 12a of the vias 11 and 12 are formed on the inner walls of the penetration holes 111 and 112 by applying a paste containing a conductive material on the dielectric layer 10 in which the penetration holes 111 and 112 are formed and by sucking the paste under the dielectric layer 10 using a vacuum. Accordingly, a conductive material having a uniform thickness is stacked on the inner walls of the penetration holes 111 and 112 to form the first portions 11a and 12a on the inner walls of the penetration holes 111 and 112 without being cut off.

Thereafter, in accordance with the antenna apparatus according to another embodiment, as illustrated in FIG. 7C, interiors of the penetration holes 111 and 112 surrounded by the first portions 11a and 12a of the vias 11 and 12 may be filled with air or a non-conductive material to form the second portions 11b and 12b of the vias 11 and 12, thereby completing the vias 11 and 12.

In accordance with the antenna apparatus according to another embodiment, as illustrated in FIG. 7C, a metallic material may be stacked on a lower surface of the dielectric layer 10 by a screen printing method, to be connected to the first portions 11a and 12a of the vias 11 and 12, thereby forming the third portions 11a1 and 12a1 of the vias 11 and 12 disposed to block the lower surfaces of the penetration holes 111 and 112. The third portions 11a1 and 12a1 of the vias 11 and 12 may not protrude from lower surfaces of the penetration holes 111 and 112, and may be disposed within the penetration holes 111 and 112.

Next, referring to FIG. 7D, the second portions 11b and 12b of the vias 11 and 12 may be formed by filling the insides of the penetration holes 111 and 112 surrounded by the first portions 11a and 12a and the third portions 11a1 and 12a1 of the vias 11 and 12 with a non-conductive material.

Thereafter, as illustrated in FIG. 7E, a metallic material may be stacked on an upper surface of the dielectric layer 10 by a screen printing method, to be connected to the first portions 11a and 12a of the vias 11 and 12, thereby forming the fourth portions 11a2 and 12a2 of the vias 11 and 12 disposed to block the upper surfaces of the penetration holes 111 and 112. The fourth portions 11a2 and 12a2 of the vias 11 and 12 may not protrude from the upper surfaces of the penetration holes 111 and 112, and may be disposed within the penetration holes 111 and 112.

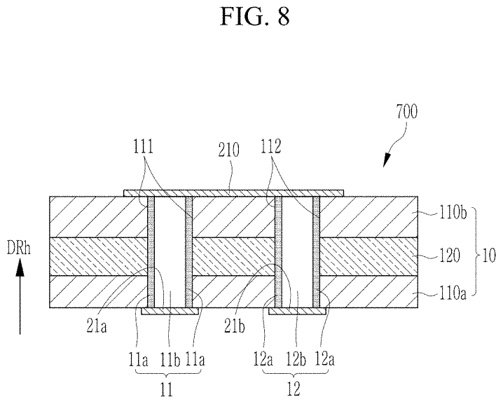

Hereinafter, an antenna apparatus 700, according to another embodiment, will be described with reference to FIG. 8. FIG. 8 illustrates a cross-sectional view of a portion of an antenna apparatus according to another embodiment.

Referring to FIG. 8, the antenna apparatus 700, according to the present embodiment, is similar to the antenna apparatus 500 according to the embodiment described above with reference to FIG. 7.

The antenna apparatus 700, according to the present embodiment, may include a first dielectric layer 110a, a second dielectric layer 110b, a third dielectric layer 120 disposed between the first dielectric layer 110a and the second dielectric layer 110b, a first via 11 and a second via 12 formed in the first dielectric layer 110a, the third dielectric layer 120, and the second dielectric layer 110b, a patch antenna 210 connected to the first via 11 and the second via 12 and disposed on the second dielectric layer 110b, and connectors 21a and 21b disposed under the first dielectric layer 110a to be connected to the first via 11 and the second via 12.

The first via 11 may include a first portion 11a disposed on an inner wall of a first penetration hole 111, and a second portion 11b disposed inside the first penetration hole 111 surrounded by the first portion 11a.

The second via 12 may include a first portion 12a disposed on an inner wall of a second penetration hole 112, and a second portion 12b disposed on an interior of the second penetration hole 112 surrounded by the first portion 12a.

The first portion 11a of the first via 11 and the first portion 12a of the second via 12 may have conductivity, and the second portion 11b of the first via 11 and the second portion 12b of the second via 12 may have non-conductivity. For example, the first portion 11a of the first via 11 and the first portion 12a of the second via 12 may include a metal, and the second portion 11b of the first via 11 and the second portion 12b of the second via 12 may include a non-conductive material such as air, glass, or ceramic.

The first portions 11a and 12a of the first via 11 and the second portions 11b and 12b of the second via 12 along the height direction DRh may be flush with the dielectric layer 10, and thus may be flush with the first penetration hole 111 and the second penetration hole 112 formed in the dielectric layer 10.

The patch antenna 210 may receive electromagnetic signals from the first via 11 and the second via 12 to transmit and receive RF signals.

In accordance with the antenna apparatus 700 according to the present embodiment, the first portions 11a and 12a of the vias 11 and 12 formed by stacking a metallic material on inner walls of the first penetration hole 111 and the second penetration hole 112 extending through the dielectric layer 10 may serve as metallic vias, and portions surrounded by the first portions 11a and 12a of the vias 11 and 12 may respectively include the second portions 11b and 12b filled with a non-conductive material, so that the first portions 11a and 12a and the third portions 11a1 and 12a1 of the conductive vias 11 and 12 may include a non-conductive material therein, thereby preventing defects such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

Many features of the antenna apparatuses 100, 200, 300, 400, 500, and 600 according to the embodiment described above are applicable to the antenna apparatus 700 according to the present embodiment.

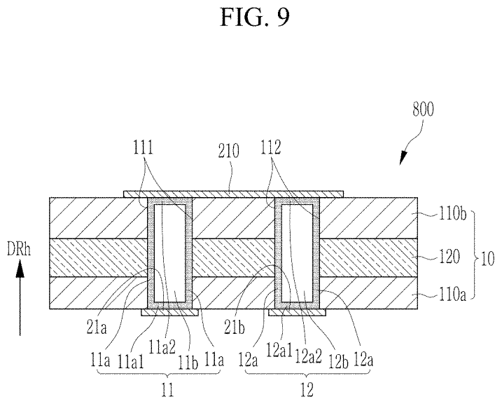

Hereinafter, an antenna apparatus 800, according to another embodiment, will be described with reference to FIG. 9. FIG. 9 illustrates a cross-sectional view of a portion of an antenna apparatus according to another embodiment.

Referring to FIG. 9, the antenna apparatus 800, according to the present embodiment, is similar to the antenna apparatus 500 according to the embodiment illustrated in FIG. 7.

The antenna apparatus 800, according to the present embodiment, may include a first dielectric layer 110a, a second dielectric layer 110b, a third dielectric layer 120 disposed between the first dielectric layer 110a and the second dielectric layer 110b, a first via 11 and a second via 12 formed in the first dielectric layer 110a, the third dielectric layer 120, and the second dielectric layer 110b, a patch antenna 210 connected to the first via 11 and the second via 12 and disposed on the second dielectric layer 110b, and connectors 21a and 21b disposed under the first dielectric layer 110a to be connected to the first via 11 and the second via 12.

The first via 11 may include a first portion 11a disposed on the inner wall of the first penetration hole 111, a third portion 11a1 connected to the first portion 11a and disposed to block a lower surface of the first penetration hole 111, a fourth portion 11a2 connected to the first portion 11a and disposed to block an upper surface of the first penetration hole 111, and a second portion 11b disposed inside the first penetration hole 111 surrounded by the first portion 11a, the third portion 11a1, and the fourth portion 11a2.

The second via 12 may include a first portion 12a disposed on the inner wall of the second penetration hole 112, a third portion 12a1 connected to the first portion 12a and disposed to block a lower surface of the second penetration hole 112, a fourth portion 12a2 connected to the first portion 12a and disposed to block an upper surface of the second penetration hole 112, and a second portion 12b disposed inside the second penetration hole 112 surrounded by the first portion 12a, the third portion 12a1, and the fourth portion 12a2.

The first portion 11a, the third portion 11a1, and the fourth portion 11a2 of the first via 11, and the first portion 12a, the third portion 12a1, and the fourth portion 12a2 of the second via 12 may have a conductive material, and the second portion 11b of the first via 11 and the second portion 12b of the second via 12 may include air.

The first via 11 and the second via 12, including the first portions 11a and 12a, the third portions 11a1 and 12a1, the fourth portions 11a2 and 12a2, and the second portions 11b and 12b along the height direction DRh may be flush with the dielectric layer 10, and may be flush with the first penetration hole 111 and the second penetration hole 112 formed in the dielectric layer 10.

The third portions 11a1 and 12a1 and the fourth portions 11a2 and 12a2 of the first via 11 and the second via 12 may not protrude from lower surfaces and upper surfaces of the penetration holes 111 and 112, and may be disposed within the penetration holes 111 and 112.

Connections between the vias 11 and 12 and the connectors 21a and 21b may be better maintained by the third portions 11a1 and 12a1 of the first via 11 and the second via 12, and connections between the vias 11 and 12 and the patch antenna 210 may be better maintained by the fourth portions 11a2 and 12a2 of the first via 11 and the second via 12.

The patch antenna 210 may receive electromagnetic signals from the first via 11 and the second via 12 to transmit and receive RF signals.

In accordance with the antenna apparatus 500 according to the present embodiment, the first portions 11a and 12a of the vias 11 and 12 are formed by stacking a metallic material on inner walls of the first penetration hole 111 and the second penetration hole 112 extending through the dielectric layer 10, and the third portions 11a1 and 12a1 and the fourth portions 11a2 and 12a2 of the vias 11 and 12 are formed by stacking the metallic material layer by a screen printing method. Accordingly, the vias 11 and 12 may include the first portions 11a and 12a, the third portions 11a1 and 12a1, and the fourth portions 11a2 and 12a2 of vias 11 and 12 serving as metallic vias, and the second portions 11b and 12b formed by filling a non-conductive material in a portion surrounded by the first portions 11a and 12a, the third portions 11a1 and 12a1, and the fourth portions 11a2 and 12a2 of the vias 11 and 12, so that the first portions 11a and 12a, the third portions 11a1 and 12a1, and the fourth portions 11a2 and 12a2 of the conductive vias 11 and 12 may include a non-conductive material, thereby preventing defects such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

Many features of the antenna apparatuses 100, 200, 300, 400, 500, 600, and 700, according to the embodiment described above, are applicable to the antenna apparatus 800 according to the present embodiment.

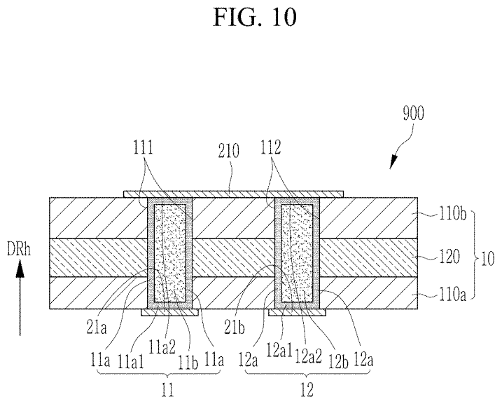

Hereinafter, an antenna apparatus 900 according to another embodiment will be described with reference to FIG. 10. FIG. 10 illustrates a cross-sectional view of a portion of an antenna apparatus according to another embodiment.

Referring to FIG. 10, the antenna apparatus 900, according to the present embodiment, is similar to the antenna apparatuses 500, 600, and 800 according to the embodiments described above with reference to FIG. 7.

The antenna apparatus 900, according to the present embodiment, may include a first dielectric layer 110a, a second dielectric layer 110b, a third dielectric layer 120 disposed between the first dielectric layer 110a and the second dielectric layer 110b, a first via 11 and a second via 12 formed in the first dielectric layer 110a, the third dielectric layer 120, and the second dielectric layer 110b, a patch antenna 210 connected to the first via 11 and the second via 12 and disposed on the second dielectric layer 110b, and connectors 21a and 21b disposed under the first dielectric layer 110a to be connected to the first via 11 and the second via 12.

The first via 11 may include a first portion 11a disposed on the inner wall of the first penetration hole 111, a third portion 11a1 connected to the first portion 11a and disposed to block a lower surface of the first penetration hole 111, a fourth portion 11a2 connected to the first portion 11a and disposed to block an upper surface of the first penetration hole 111, and a second portion 11b disposed inside the first penetration hole 111 surrounded by the first portion 11a, the third portion 11a1, and the fourth portion 11a2.

The second via 12 may include a first portion 12a disposed on the inner wall of the second penetration hole 112, a third portion 12a1 connected to the first portion 12a and disposed to block a lower surface of the second penetration hole 112, a fourth portion 12a2 connected to the first portion 12a and disposed to block an upper surface of the second penetration hole 112, and a second portion 12b disposed inside the second penetration hole 112 surrounded by the first portion 12a, the third portion 12a1, and the fourth portion 12a2.

The first portion 11a, the third portion 11a1, and the fourth portion 11a2 of the first via 11, and the first portion 12a, the third portion 12a1, and the fourth portion 12a2 of the second via 12 may have conductivity, and the second portion 11b of the first via 11 and the second portion 12b of the second via 12 may have non-conductivity. For example, the first portion 11a, the third portion 11a2, and the fourth portion 11a2 of the first via 11 and the first portion 12a, the third portion 12a2, and the fourth portion 12a2 of the second via 12 may include a metal, and the second portion 11b of the first via 11 and the second portion 12b of the second via 12 may include a non-conductive material such as glass or ceramic rather than air.

The first via 11 and the second via 12, including the first portions 11a and 12a, the third portions 11a1 and 12a1, the fourth portions 11a2 and 12a2, and the second portions 11b and 12b along the height direction DRh may be flush with the dielectric layer 10, and may be flush with the first penetration hole 111 and the second penetration hole 112 formed in the dielectric layer 10.

The third portions 11a1 and 12a1 and the fourth portions 11a2 and 12a2 of the first via 11 and the second via 12 may not protrude from lower surfaces and upper surfaces of the penetration holes 111 and 112, and may be disposed within the penetration holes 111 and 112.

Connections between the vias 11 and 12 and the connectors 21a and 21b may be better maintained by the third portions 11a1 and 12a1 of the first via 11 and the second via 12, and connections between the vias 11 and 12 and the patch antenna 210 may be better maintained by the fourth portions 11a2 and 12a2 of the first via 11 and the second via 12.

The second portion 11b of the first via 11 and the second portion 12b of the second via 12 may be filled with a non-conductive material, thereby more stably maintaining a shape of the vias 11 and 12.

The patch antenna 210 may receive electromagnetic signals from the first via 11 and the second via 12 to transmit and receive RF signals.

In accordance with the antenna apparatus 900 according to the present embodiment, the first portions 11a and 12a of the vias 11 and 12 are formed by stacking a metallic material on the inner walls of the first penetration hole 111 and the second penetration hole 112 extending through the dielectric layer 10, and the third portions 11a1 and 12a1 and the fourth portions 11a2 and 12a2 of the vias 11 and 12 are formed by stacking a metallic material by a screen printing method. Accordingly, the vias 11 and 12 may include the first portions 11a and 12a, the third portions 11a1 and 12a1, and the fourth portions 11a2 and 12a2 of vias 11 and 12 serving as metallic vias, and the second portions 11b and 12b formed by filling a non-conductive material in a portion surrounded by the first portions 11a and 12a, the third portions 11a1 and 12a1, and the fourth portions 11a2 and 12a2 of the vias 11 and 12, so that the first portions 11a and 12a, the third portions 11a1 and 12a1, and the fourth portions 11a2 and 12a2 of the conductive vias 11 and 12 may include a non-conductive material, thereby preventing defects such as no electrical signal being transferred through the via because a conducting material layer is broken inside the via due to insufficient filling of a conductive material inside the via, or an empty space being formed inside some vias depending on a position of the via. Accordingly, it is possible to prevent deterioration in the performance of the antenna apparatus, which may occur by a defect in the antenna apparatus due to poor filling of the via or non-uniformity of the conductive layer inside the via depending on the position of the via.

Many features of the antenna apparatuses 100, 200, 300, 400, 500, 600, 700, and 800, according to the embodiment described above, are applicable to the antenna apparatus 900 according to the present embodiment.

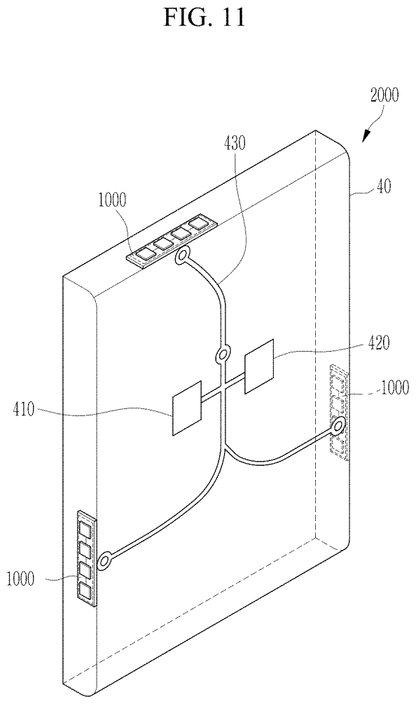

Hereinafter, an electronic device, including an antenna apparatus according to an embodiment will be described with reference to FIG. 11. FIG. 11 illustrates a schematic diagram showing an electronic device, including an antenna apparatus according to an embodiment.

Referring to FIG. 11, the electronic device 2000, according to the present embodiment, includes an antenna apparatus 1000, and the antenna apparatus 1000 is disposed in a set 40 of the electronic device 2000.

For example, the electronic device 2000 may be a smart phone, a personal digital assistant, a digital video camera, a digital still camera, a network system, a computer, a monitor, a tablet, a laptop, a network, a television, a video game, a smart watch, an automotive device, or the like, but the embodiment is not limited thereto.

The electronic device 2000 may have polygonal sides, and the antenna apparatus 1000 may be disposed adjacent to at least some of the sides of the electronic device 2000.

The set 40 may further include a communication module 410 and a baseband circuit 420. The antenna apparatus may be connected to the communication module 410 and/or the baseband circuit 420 through a coaxial cable 430.

The communication module 410 may include at least some of a memory chip such as a volatile memory (e.g. a DRAM), a non-volatile memory (e.g. a ROM), a flash memory, etc., an application processor chip such as a central processor (e.g., a CPU), a graphics processor (e.g., a GPU), a digital signal processor, a cryptographic processor, a microprocessor, or a microcontroller, or a logic chip such as an analog-to-digital converter or an application-specific IC (ASIC), to perform digital signal processing.

The baseband circuit 420 may generate a base signal by performing analog-to-digital conversion, and amplification, filtering, and frequency conversion on the analog signal. A base signal inputted and outputted from the baseband circuit 420 may be transferred to the antenna apparatus through a cable.

For example, the base signal may be transferred to an IC through an electrical connection structure, a core via, and a wire. The IC may convert the base signal into an RF signal of a millimeter wave (mmWave) band.

The antenna apparatus 1000 may include any one of the aforementioned antenna apparatus 100 to 900.

Many features of the antenna apparatuses 100 to 900 according to the embodiment described above are applicable to the antenna apparatus 1000 of the electronic device 2000.

Embodiments have been made in an effort to provide an antenna apparatus capable of preventing a defect due to vias, thereby preventing deterioration of antenna performance even when an antenna size is reduced.

It may be possible to prevent a defect due to vias, thereby preventing deterioration of antenna performance even when an antenna size is reduced.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna apparatus comprising:
a dielectric layer; and
a via that extends through the dielectric layer, the via comprising a conductive first portion and a non-conductive second portion surrounded by the conductive first portion,
wherein an antenna of the antenna apparatus is fed through the via.

2. The antenna apparatus of claim 1, wherein
the conductive first portion and the non-conductive second portion, in a thickness direction of the via, have respective upper and/or lower surfaces aligned with a respective upper surface or lower surface of the dielectric layer.

3. The antenna apparatus of claim 2, wherein
the via further includes a lower surface that includes a conductive third portion connected to the lower surface of the conductive first portion.

4. The antenna apparatus of claim 3, wherein
the third portion of the via is flush with, or higher than, a plane of the lower surface of the dielectric layer.

5. The antenna apparatus of claim 4, wherein
the via further includes an upper surface that includes a conductive fourth portion connected to the upper surface of the conductive first portion.

6. The antenna apparatus of claim 5, wherein
the fourth portion of the via is flush with, or lower than, a plane of the upper surface of the dielectric layer.

7. The antenna apparatus of claim 6, wherein
the conductive first portion, the third portion, and the fourth portion of the via surround the non-conductive second portion.

8. The antenna apparatus of claim 6, further comprising
a patch antenna fed from the via.

9. The antenna apparatus of claim 8, wherein
the patch antenna is connected to the conductive first portion through the fourth portion.

10. The antenna apparatus of claim 6, further comprising
a plurality of connectors disposed under the first dielectric layer.

11. The antenna apparatus of claim 10, wherein
a subset of the connectors are connected to the conductive first portion of the via through the third portion.

12. The antenna apparatus of claim 2, wherein
the conductive first portion includes a metal, and
the non-conductive second portion includes at least one of air, glass, or ceramic.

13. The antenna apparatus of claim 2, wherein
the dielectric layer includes a first dielectric layer, a second dielectric layer disposed on the first dielectric layer, and a third dielectric layer disposed between the first dielectric layer and the second dielectric layer,
a dielectric constant of the third dielectric layer is lower than dielectric constants of the first dielectric layer and the second dielectric layer, and
the via is disposed in at least the first dielectric layer.

14. The antenna apparatus of claim 13, further comprising:
a feed patch antenna formed on the first dielectric layer and fed from the via; and
a coupling patch formed on the second dielectric layer and coupled to the feed patch antenna.

15. The antenna apparatus of claim 13, wherein
the dielectric layer has a hexahedron shape extending in a first direction, a second direction perpendicular to the first direction, and a third direction perpendicular to the first direction and the second direction.

16. The antenna apparatus of claim 13, further comprising
a plurality of connectors disposed under the first dielectric layer.

17. The antenna apparatus of claim 16, wherein
a subset of the connectors are connected to the conductive first portion of the via.

18. An antenna apparatus comprising:
a dielectric layer; and
a via that extends through the dielectric layer, the via comprising a conductive first portion and a non-conductive second portion,
wherein the conductive first portion and the non-conductive second portion have respective upper and/or lower surfaces aligned with a respective upper surface or lower surface of the dielectric layer.

19. The antenna apparatus of claim 18, wherein
the via further includes a third portion connected to the conductive first portion and disposed on a lower surface of the via, and a fourth portion connected to the conductive first portion and disposed on an upper surface of the via, and
the third portion and the fourth portion are disposed within the via.

20. The antenna apparatus of claim 18, wherein
the conductive first portion includes a metal, and
the non-conductive second portion includes at least one of air, glass, or ceramic.
